(19) United States
(12) Patent Application Publication
(10) Pub. No.: US 2003/0133008 A1
(43) Pub. Date: Jul. 17, 2003

(54) WEARABLE PANORAMIC IMAGER

(76) Inventor: STANLEY W. STEPHENSON, SPENCERPORT, NY (US)

Correspondence Address: PATENT LEGAL STAFF, EASTMAN KODAK COMPANY, 343 STATE STREET, ROCHESTER, NY, 14650-2201, US

(21) Appl. No.: 09/241,700

(22) Filed: Feb. 2, 1999

(51) Int. Cl. H04N 7/00

(52) U.S. Cl. 348/47; 348/143

(57) ABSTRACT

A user wearable apparatus for forming digital images of selected scenes which are adapted to form panoramic images, including a plurality of digital cameras supported on the user and positioned to have overlapping fields of view. The user wearable apparatus actives selected digital cameras to cause such digital cameras to simultaneously capture digital images which are adapted to be used in producing the panoramic image. The captured digital images are stored in selected locations so that they can be retrieved to form the panoramic image.

### FIELD OF THE INVENTION

The present invention relates to capturing digital images which can be used to form panoramic images.

### BACKGROUND OF THE INVENTION

A variety of composing and display systems have been commercialized to create and view 360 degree panoramic images. In Byte Magazine, May 1995 issue, an article “See You Around” by Tom R. Halfhill on pages 85-90 describes software programs operating on digitally stored files having a 360 degree panoramic view. The systems create a digital image file with a 360 degree field of view from knitting together overlapping images or from a single 360 degree field of view image. Another system from IPIX Corporation uses a photographic camera to capture two complementary 180 degree views with a fisheye lens. An IPIX computer program knits digital data from the two 180 degree views and corrects for optical distortion from the fish-eye lens to generate a digital 360 degree panoramic view.

U.S. Pat. No. 5,752,113 discloses a mount for an image capture device with sequentially indexed motion through 360 degrees of rotation. The frame can hold either a silver halide or electronic cameras. U.S. Pat. No. 5,650,813 discloses a rotating optical system that scans a panoramic view onto an electronic sensor. U.S. Pat. No. 5,657,073 discloses a set of cameras facing in various directions. The image data from the cameras is transformed to remove distortion in the over lapping images and creates a panoramic scene. Control means selects a portion of the panoramic images through a display device having separate image streams to each of the viewer's eyes.

The prior art has the disadvantage of being bulky, not wearable and having the potential for an operator interfering with the field of view.

### SUMMARY OF THE INVENTION

It is an object of the present invention to provide user wearable apparatus that provides a simple way for a user to capture panoramic images.

It is a further object of the present invention to produce panoramic or panaspheric images in a wearable device.

These objects are achieved by a user wearable apparatus for forming digital images of selected scenes which are adapted to be used in forming panoramic images, comprising:

(a) a plurality of digital cameras supported on the user and positioned to have overlapping fields of view;

(b) user activated means for activating selected digital cameras to cause such digital cameras to simultaneously capture digital images which are adapted to be used in forming the panoramic image; and

(c) means for storing such captured digital images in selected locations so that they can be retrieved to form the panoramic image.

It is an advantage of the apparatus in accordance with the present invention to be attachable to a user for portability.

A further feature of the present invention is that the apparatus permits image capture without a user being in the field of view.

### BRIEF DESCRIPTION OF THE DRAWINGS

FIG. 1 is a view of a user wearable apparatus in accordance with the present invention;

FIG. 2 is a top view of FIG. 1 showing overlapping fields of view for a plurality of cameras;

FIG. 3 is a block diagram of one of the digital cameras shown in FIG. 1;

FIG. 4 is a block diagram of apparatus in accordance with the present invention showing their electrical interconnection;

FIG. 5 is another block diagram of a different embodiment apparatus in accordance with the present invention showing their electrical interconnection;

FIG. 6 is yet another block diagram of a different embodiment apparatus in accordance with the present invention showing their electrical interconnection; and

FIG. 7 is a view similar to FIG. 1 wherein the digital cameras are fastened to garment which provides an electrical interconnection.

### DETAILED DESCRIPTION OF THE PREFERRED EMBODIMENTS

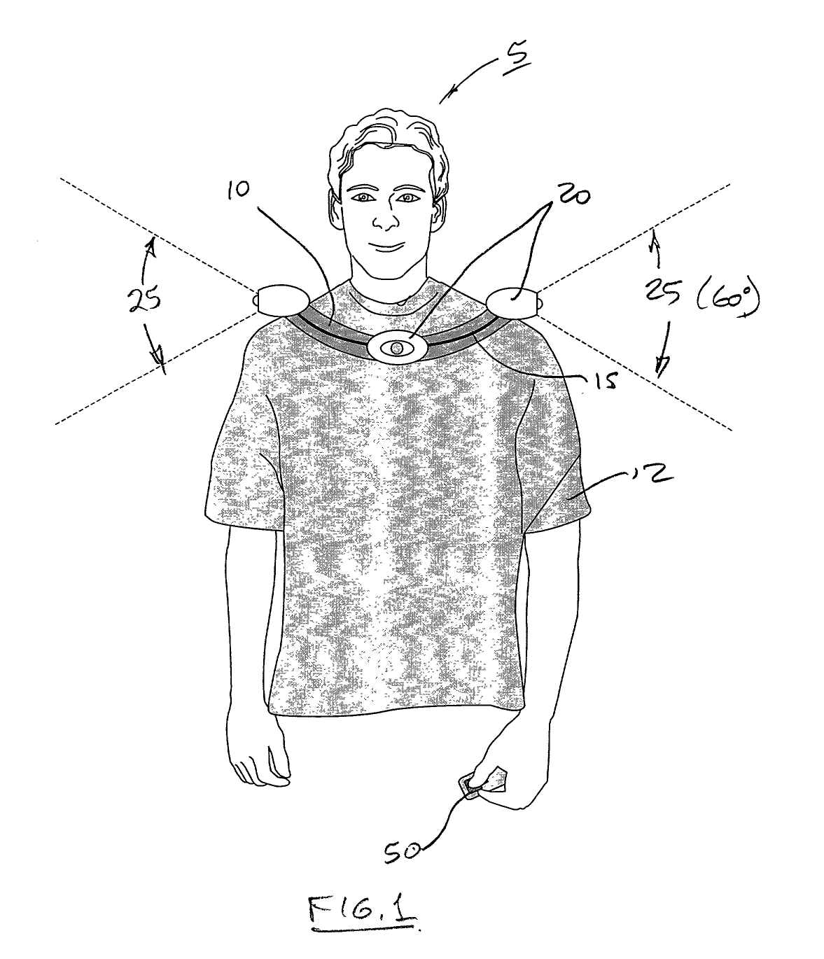

In FIG. 1 there is shown a user 5 who wears a frame 10. The frame 10 is worn by the user 5 and can be integral with garment 12. Garment 12 can be a harness, a vest, a shirt or strips of material providing securing means to a user's body. In the preferred embodiment, frame 10 rests on the shoulders of user 5. Alternatively, frame 10 can be removable and attachable to garment 12. Frame 10 can also be attached to or integral with the frame of a pair of glasses worn by the user 5 or a head covering, such as a hat, worn by the user 5.

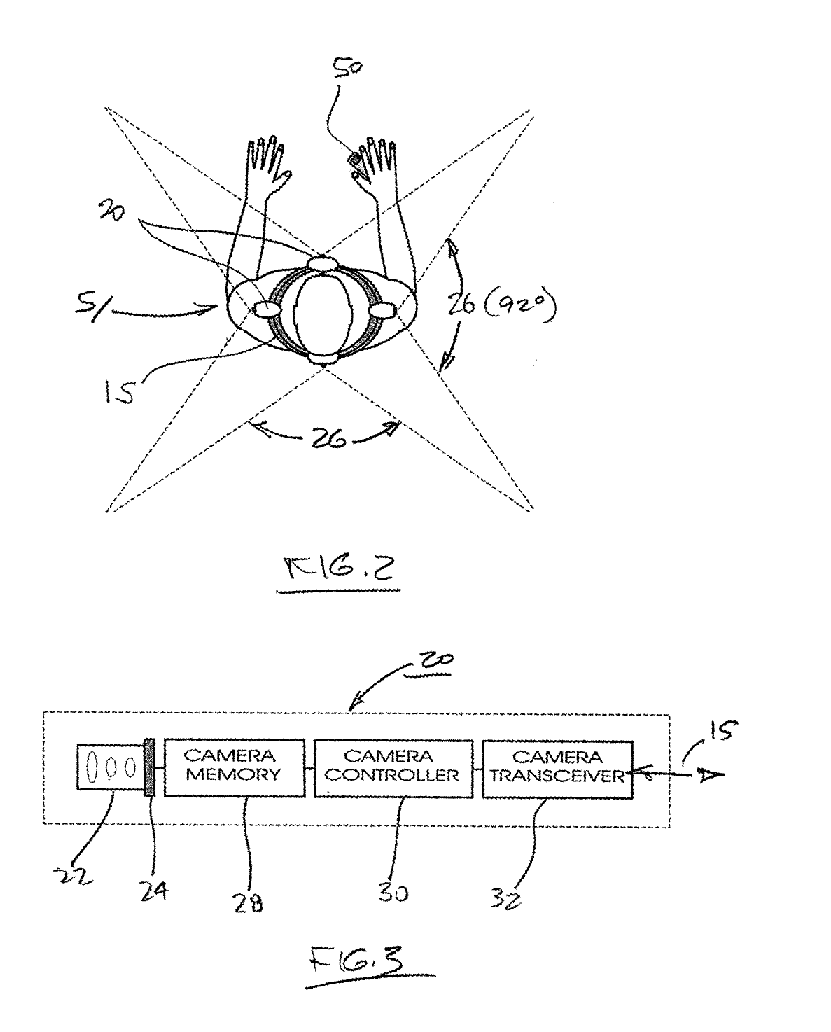

A plurality of digital cameras 20 are attached on the frame 10. Each digital camera 20 has a vertical field of view 25 of approximately 60 degrees. Four digital cameras 20 are disposed on frame 10, one each pointing to the front and back, and one each pointing to either side of user 5. As shown in FIG. 2, the arrangement of digital cameras 20 permits a simultaneous 360 degrees of field of view around the user 5 without the user's 5 body blocking a horizontal field of view 26. Digital cameras 20 are electronically connected to interconnect bus 15, which is disposed in frame 10. Interconnect bus 15 can take many different forms known in the art, such as a coaxial cable connected between digital cameras 20. The interconnect bus 15 permits high speed digital data to be transferred between each digital camera 20.

User 5 can hold a remote 50 that is used to trigger image capture by digital cameras 20. Remote 50 and frame 10 are two separate devices that cooperate through electrical transmission 80. In the arrangement of FIG. 1, transmission 80 is accomplished through a Personal Area Network (PAN) which uses the body of user 5 to transmit data. The body of remote 50 is electrically conductive and transmits signals in the body of user 5 when held and activated by user 5. Electrode 82 in frame 10 contacts an user's 5 body. (See “Personal Area Networks (PAN): Near-Field Intra-Body Communication” by Thomas Zimmerman, IBM Systems Journal 35, pp. 609-618 (1996). When remote 50 is held, a conducting outer surface on remote 50 acts as an electrode connection to the user's body. Frame 10 is in contact with the body of user 5 to permit communication between remote 50 and digital cameras 20.

Alternatively, radio frequencies or infrared transmission can be used by remote 50 to trigger image capture without using an user's 5 body as a signal guide. A PAN is preferred because a radio frequency signal creates local signal emissions that may affect nearby apparatus. Alternatively, an electrically conductive trace can be provided between remote 50 and digital cameras 20.

In FIG. 2, each digital camera 20 has optics 22 which capture a wide horizontal field of view 26. In this arrangement four digital cameras 20 are disposed on frame 10, with each digital camera 20 having a 92 degree field of view 26. The digital cameras 20 are disposed to provide a slight overlap between each adjacent horizontal field of view 26.

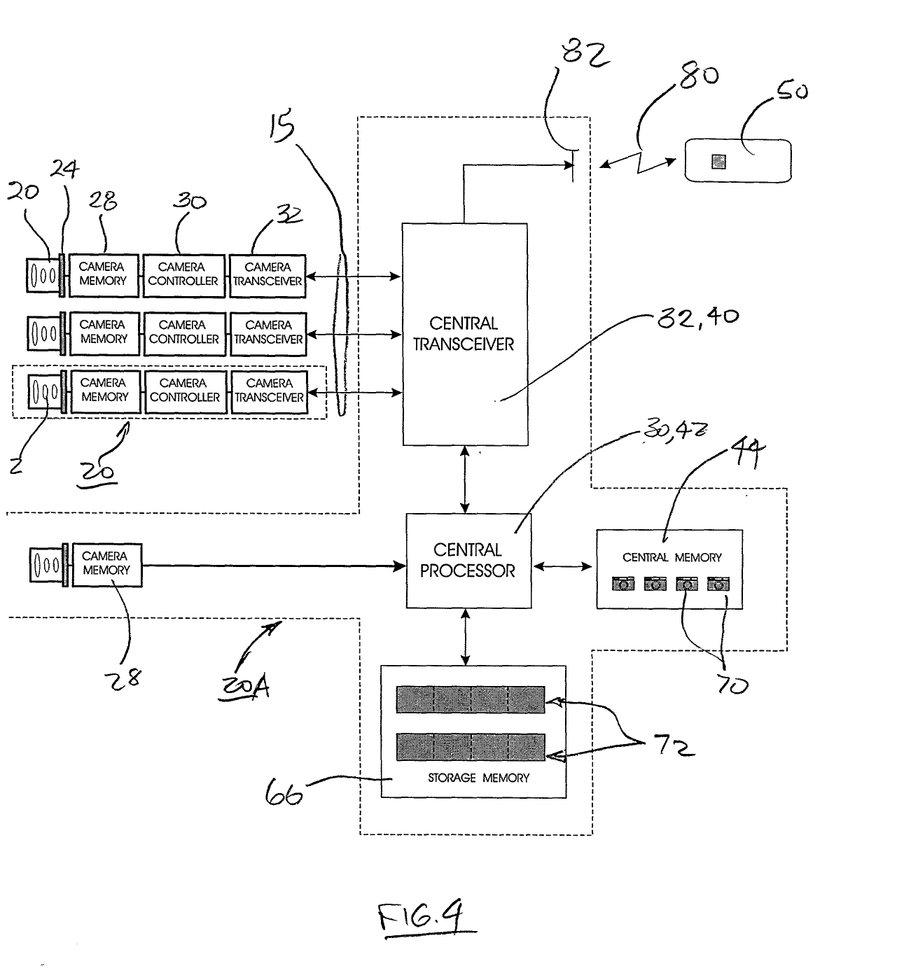

FIG. 3 is an electrical block diagram of an individual digital camera 20. Image sensor 24 is of conventional design and has a 3:4 aspect ratio corresponding conventional video sensor aspect ratio. Image sensor 24 is an integrated circuit having 800 rows and 1200 columns of 8 micron square sensing elements. Each optic 22 is a set of lenses with an effective focal length of 5 millimeters. The size of image sensor 24 and the focal length of optics 22 provide the 92 degree horizontal field of view and the 60 degree vertical field of view of digital cameras 20.

Camera controller 30 includes camera transceiver 32 which receives signals from and transmits data on interconnect bus 15. Camera controller 30 can receive a “capture image” signal indicating that each digital camera 20 should capture an image. Upon receiving such a signal, each camera controller 30 operates on its image sensor 24 to transfer image data from its image sensor 24 to its camera memory 28. Each digital camera 20 can also receive a “transmit image” signal along with as camera identification number. If the camera identification number matches a given camera, that camera's camera controller 30 operates on the camera transceiver 32 to transmit image data corresponding to a captured image from camera memory 28 to interconnect bus 15.

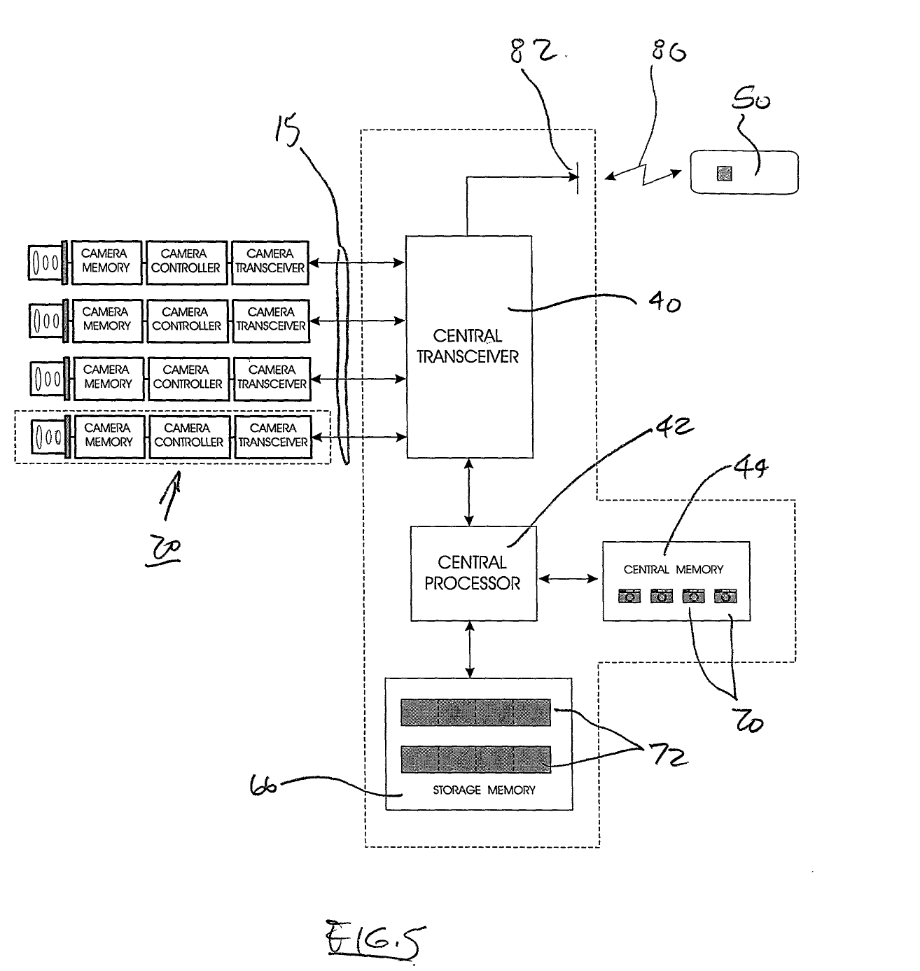

FIG. 4 is a circuit diagram of the user wearable digital panoramic camera apparatus of the present invention. Frame 10 supports digital cameras 20 by user 5. The user 5 operates the master digital camera 20A to control the capture, transmission and storage of images from other digital cameras 20. Master digital camera 20A uses its camera transceiver 32 as central transceiver 40. Master digital camera 20A uses its camera controller 30 as a central processor 42. An electrode 82 in contact with user 5's body in master digital camera 20A provides connection to the PAN.

A “capture image” signal from remote 50 is received by master digital camera 20A using central transceiver 40 and retransmitted by master digital camera 20A onto interconnect bus 15. The PAN has limited transmission speed, and is useful for transmitting simple triggering signals; however it is advantageous to also have interconnect bus 15, which provides faster transmission of captured images.

The user 5 signals central processor 42 to transmit the “capture image” signal through interconnect bus 15 to all other digital cameras 20. Central processor 42 acts on its own image sensor 24 and transfers its image data to its own camera memory 28. Other digital cameras 20 on interconnect bus 15 transfer an image from their respective image sensors 24 to the their respective camera memory 28 in response to the “capture image” signal from central processor 42. A common trigger signal is needed to permit simultaneous capture. If capture timing is not simultaneous, time induced motion errors can be introduced into a final image composite image.

Central processor 42 then sequentially polls each digital camera 20 to receive image data from each digital camera 20. Master digital camera 20A transmits a “transmit image” command and a camera specific identification code on interconnect bus 15. A digital camera 20 having that specific identification code then transfers image data stored in its camera memory 28 through interconnect bus 15 to central transceiver 40. Central processor 42 receives image data from central transceiver 40 and stores the image data as one of still images 70 in central memory 44. Central processor 42 sends a “transmit image” signal with successive identification codes to each camera on interconnect bus 15, and receives the respective images until a set of images is stored in central memory 44 that comprises a 360 degree field of view.

Central processor 42 can operate on still images 70 to combine still images 70 into a single seamless panorama image 72 which is stored in storage memory 72. Alternatively, the set of still images 70 that have been simultaneously captured can be stored as a single record having separate images to create an unprocessed panorama image 72.

Storage memory 72 can be a removable semiconductor memory element conforming to current standards such as a CompactFlash™ card, a SmartMedia™ card or a PCMCIA memory cardtm. Alternatively, storage memory 72 can be a magnetic or optical recording drive conforming to semiconductor memory card standards and having sufficient capacity to store a plurality of recording segments. In the case of a recording medium, storage memory 72 can also be a writable Compact Disk™ or digital magnetic tape. Storage memory 72 should have sufficient capacity to store a plurality of recording intervals. For example, this may be a 300 megabyte disk drive storing 65 unprocessed panorama images 72.

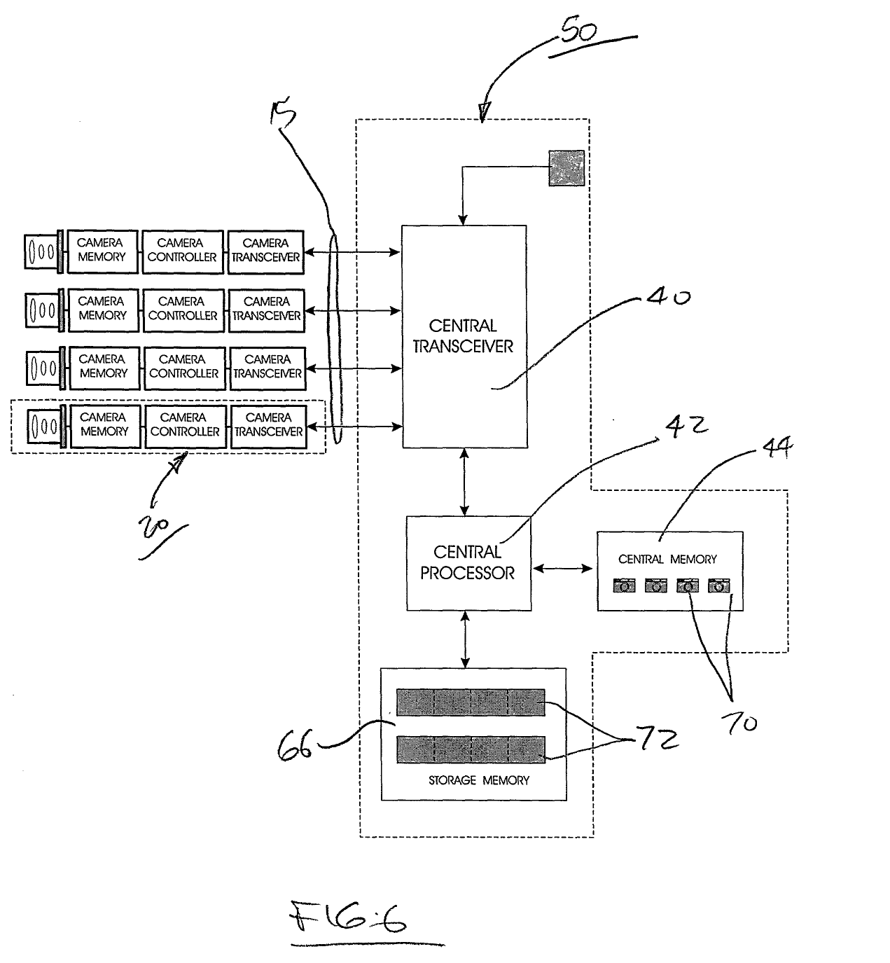

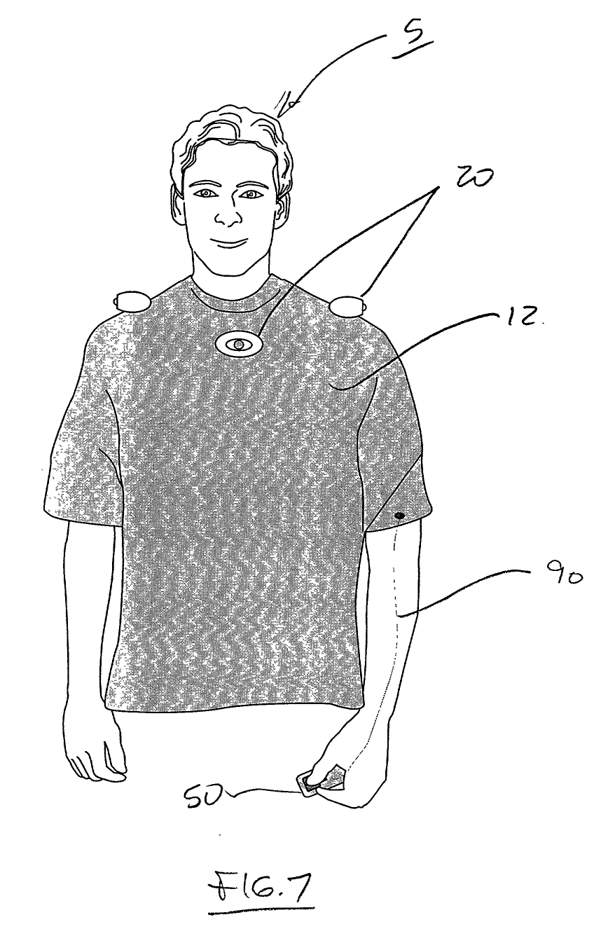

Alternative structures can be used in the invention. In FIG. 5, frame 10 itself include components having central transceiver 40, central processor 42, central memory 44 and storage memory 66. The components in frame 10 include central transceiver 40 that operate on a command from remote 50 to capture a 360 degree field of view using digital cameras 20. The central components in FIG. 6 are another embodiment of the invention using remote 50 to include the central imaging components. Where the parts correspond, the previously assigned component numbers are used.

FIG. 7 is a final embodiment which does not require the use of frame 10. Garment 12 supports digital cameras 20. Garment 12 can be provided by fine metallic wire incorporated in a fabric to provide a wearable interconnect bus 15. Garment 12 is flexible, and digital cameras 20 are not supported rigidly to each other. Optics 22 with a 92 degree horizontal field of view, producing marginally overlapping fields of view. The focal length of optics 22 can be reduced in the frame-less configuration to increase the overlap to capture a 360 degree panorama to compensate for digital cameras 20 being out of position if user 5 flexes garment 12. Captured images in the frame-less embodiment require compensation for misalignment. Central processor 42 can determine degree of misalignment and compensate for camera misalignment using techniques such as those disclosed in U.S. Pat. No. 5,706,416.

When the garment 12 is conductive, remote 50 can be directly wired into the fabric. Alternatively, garment 12 can have remote 50 directly attached. Remote 50 can be a “button” structure that is attached to the body of garment 12. A compact button style remote 50 can contain a small battery, an oscillator and a pressed switch which provides a simple on-off signal to conductive fabric in garment 12. A button remote 50 should be located outside the fields of view 25 and 26 of digital cameras 20 so that panoramic images can be captured without parts of the body of user 5 being in the scene. Such a remote 50 can be incorporated onto a sleeve or appear as a medallion-like structure on garment 12.

The invention has been described in detail with particular reference to certain preferred embodiments thereof, but it will be understood that variations and modifications can be effected within the spirit and scope of the invention.

### Parts List

5 user

10 frame

12 garment

15 interconnect bus

20 digital camera

20A master digital camera

22 optic

24 image sensor

25 vertical field of view

26 horizontal field of view

28 camera memory

30 camera controller

32 camera transceiver

40 central transceiver

42 central processor

44 central memory

50 remote

66 storage memory

70 still images

72 panorama images

80 transmission

82 electrode

90 interconnect line

What is claimed is:

1. A user wearable apparatus for forming digital images of selected scenes which are adapted to be used in forming panoramic images, comprising:
(a) a plurality of digital cameras supported on the user and positioned to have overlapping fields of view;
(b) user activated means for activating selected digital cameras to cause such digital cameras to simultaneously capture digital images which are adapted to be used in forming the panoramic image; and
(c) means for storing such captured digital images in selected locations so that they can be retrieved to form the panoramic image.

2. The invention of claim 1 wherein the user activated means includes image processor means for receiving and storing the digital image captured by the digital camera.

3. The invention of claim 2 wherein the image processor means includes a transceiver and a remote control unit for signaling the transceiver and means coupled to the transceiver for activating the digital cameras.

4. The invention of claim 1 further including an electrically conductive user garment and means for attaching the digital cameras to the electrically conductive user garment which provides electrical connections for the digital cameras.

5. The invention of claim 1 further including an electrically conductive user garment, and a remote control unit attached to the electrically conductive user garment and means for attaching the digital cameras to the electrically conductive user garment which provides electrical connections for the digital cameras.

6. A user wearable apparatus for forming digital images of selected scenes which are adapted to form panoramic images, comprising:
(a) a user wearable rigid frame;
(b) a plurality of digital cameras supported at predetermined fixed positions on the user wearable rigid frame and positioned to have overlapping fields of view;
(c) user activated means for activating selected digital cameras to cause such digital cameras to simultaneously capture digital images which are adapted to be used in producing the panoramic image;
(d.) means for storing such captured digital images in selected locations so that they can be retrieved to form the panoramic image; and
(e) means for processing such captured digital images to form the panoramic digital image.

7. The invention of claim 6 wherein the user activated means includes image processor means for receiving and storing the digital image captured by the digital camera.

8. The invention of claim 6 wherein the image processor means includes a transceiver and a remote control unit for signaling the transceiver and means coupled to the transceiver for activating the digital cameras.
